(19) United States
(12) Patent Application Publication
(10) Pub. No.: US 2025/0245976 A1
(43) Pub. Date: Jul. 31, 2025

(54) TRAINING DEVICE FOR MACHINE LEARNING AND TRAINING METHOD THEREFOR

(71) Applicant: Fukashi Andoh, Nagoya (JP)

(72) Inventor: Fukashi Andoh, Nagoya (JP)

(21) Appl. No.: 18/424,793

(22) Filed: Jan. 27, 2024

(51) Int. Cl. G06V 10/82; G06V 10/776

(52) U.S. Cl. CPC G06V 10/82; G06V 10/776

(57) ABSTRACT

A neural network for image classification. An image input device receives an image. A feature identification unit identifies a plurality of features, and sends a plurality of identified features. A feature classification unit classifies the identified features, and sends a plurality of feature classifications. A feature classification evaluator sends an image classification initiation signal if sum of the feature percentages associated with one of the feature classifications exceeds a prespecified value, and sends the undertrained network selection signal otherwise. An image classification unit generates an image classification.

### BACKGROUND OF THE INVENTION

The present invention relates to a neural network for image classification.

The artificial neural network for image classification is trained to optimize the weights so that the network can correctly classify the images supplied. The training usually requires impossibly large number of training sample images manually supplied, because the network can classify correctly only the images similar to the training sample images. This has been one of the major limiting factors for the use of neural networks in some critical applications, such as full driving automation and fully-autonomous surgery. To construct a neural network capable of classifying the images different from the ones manually supplied, variations of sample images are generated automatically using augmentation. Even with augmentation, however, the neural network is not capable of correctly classifying images significantly different from the training sample images.

U.S. Pat. No. 11,048,985 B2 (hereinafter referred to as “prior art 1”) discloses a method and system classifying an image by extracting features unique to the class of the image, ones in common with other classes, ones never found in the class, and ones never contributing to any class. As an alternative way to improve accuracy of image classification, U.S. Pat. No. 11,048,982 B2 (hereinafter referred to as “prior art 2”) discloses a method for adopting the classification result from a neural network that is historically capable of detecting and identifying certain images better.

The prior arts 1 and 2 fail to classify with accuracy sufficient to critical applications the images whose orientation is significantly different from the training sample images, for example rear view images of a cat will be classified by the network while only front and side view images were supplied for training.

### SUMMARY OF THE INVENTION

The present invention provides a neural network for image classification and classification method thereof that can correctly classify images significantly different from the training sample images.

The neural network for image classification includes:
an image input device receiving an image and sending the image to a feature identification unit;
the feature identification unit receiving the image from the image input device and an undertrained network selection signal from a feature classification evaluator, identifying a plurality of features using an undertrained network, and sending a plurality of identified features to a feature classification unit;
the feature classification unit receiving the identified features from the feature identification unit, classifying the identified features, and sending a plurality of feature classifications and a plurality of feature percentages to the feature classification evaluator;
the feature classification evaluator receiving the feature classifications and the feature percentages from the feature classification unit, sending an image classification initiation signal to the image classification unit if sum of the feature percentages associated with one of the feature classifications exceeds a prespecified value, and sending the undertrained network selection signal to the feature identification unit otherwise; and
the image classification unit receiving the image classification initiation signal from the feature classification evaluator, and generating an image classification.

The method for the neural network for image classification includes:
receiving an image;
identifying a plurality of features of the image, and generating a plurality of identified features;
classifying the identified features, and generating a plurality of feature classifications and a plurality of feature percentages;
checking if sum of the feature percentages associated with one of the feature classifications exceeds a prespecified value;
checking if the neural network was switched for prespecified times;
switching to an undertrained network if the sum of the feature percentages does not exceed the prespecified value, and the neural network was not switched for prespecified times;
notifying the image is unclassifiable if the neural network was switched for prespecified times;
passing the feature classifications to a plurality of image classification layers if the sum of the feature percentages exceeds the prespecified value; and
classifying the image, and generating an image classification.
   The construction and procedure of the present invention help avoid over-fitting to the training sample images, and are capable of correctly classifying an image significantly different from the training sample images.

### BRIEF DESCRIPTION OF THE DRAWINGS

The novel features of the invention will be readily understood and appreciated by reference to the following detailed description taken in conjunction with the drawings, in which:

FIG. 1 is a block diagram of a neural network for image classification in accordance with an exemplary embodiment of the invention;

FIG. 2 is a flowchart showing a processing flow of a neural network for image classification in accordance with an exemplary embodiment of the invention;

FIG. 3 is a simulation result of an exemplary embodiment of the invention showing accuracy and loss in training and validating the neural network;

FIG. 4 is a simulation result showing accuracy and loss in training and validating the neural network according to the prior art 1;

FIG. 5 is a simulation result showing accuracy and loss in training and validating GoogLeNet used as a part of the prior art 2;

### DETAILED DESCRIPTION OF THE INVENTION

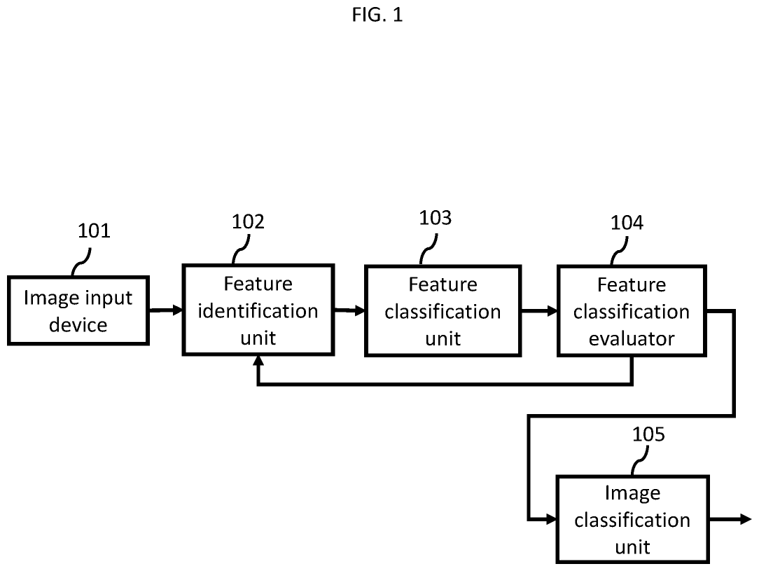

FIG. 1 is a block diagram of a neural network for image classification in accordance with an exemplary embodiment of the invention. The neural network for image classification includes: an image input device 101, a feature identification unit 102, a feature classification unit 103, a feature classification evaluator 104, and an image classification unit 105.

The image input device 101 receives an image and sends the image to a feature identification unit 102.

The feature identification unit 102 receives the image from the image input device 101 and an undertrained network selection signal from the feature classification evaluator 104, identifies a plurality of features using an undertrained network, and sends a plurality of identified features to the feature classification unit 103.

The feature classification unit 103 receives the identified features from the feature identification unit 102, classifies the identified features, and sends a plurality of feature classifications and a plurality of feature percentages to the feature classification evaluator 104.

The feature classification evaluator 104 receives the feature classifications and the feature percentages from the feature classification unit 103, sends an image classification initiation signal to the image classification unit 105 if sum of the feature percentages associated with one of the feature classifications exceeds a prespecified value, and sends the undertrained network selection signal to the feature identification unit 102 otherwise.

The image classification unit 105 receives the image classification initiation signal from the feature classification evaluator 104, and generates an image classification.

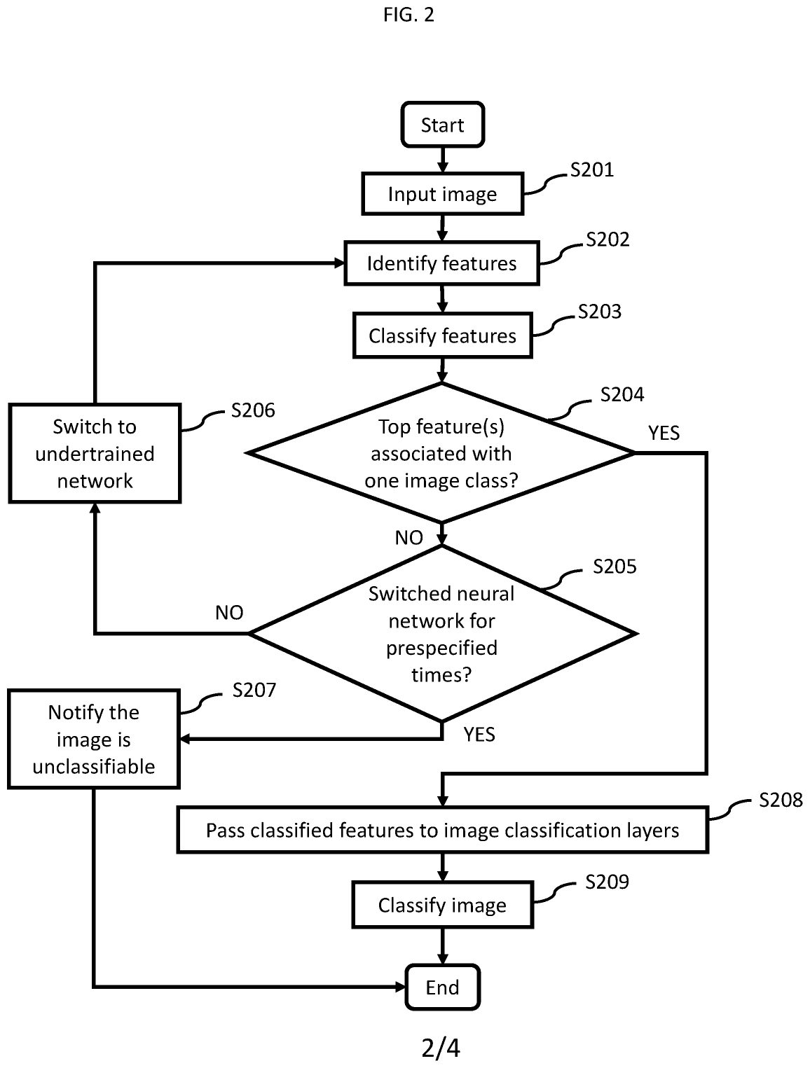

FIG. 2 is a flowchart showing a processing flow of a neural network for image classification in accordance with an exemplary embodiment of the invention.

An image is received (S201).

A plurality of features of the image is identified, and a plurality of identified features are generated (S202).

The identified features are classified, and a plurality of feature classifications and a plurality of feature percentages are generated (S203).

It is checked if sum of the feature percentages associated with one of the feature classifications exceeds a prespecified value (S204).

It is checked if the neural network was switched for prespecified times (S205).

An undertrained network is selected if the sum of the feature percentages does not exceed the prespecified value, and the neural network was not switched for prespecified times (S206).

It is notified that the image is unclassifiable if the neural network was switched for prespecified times (S207).

The feature classifications are passed to a plurality of image classification layers if the sum of the feature percentages exceeds the prespecified value (S208).

The image is classified, and an image classification is generated (S209).

Hereinafter, simulation results of aforementioned procedure of the neural network training method in accordance with an exemplary embodiment of the invention is described in detail. The simulation is aimed at testing whether rear-view images are correctly classified by the neural networks of the present invention while only front- and side-view images are supplied for training. The simulation assumes a neural network comprising 9 feature identification layers, a feature classification layer, and an image classification layer. Each of the feature identification layers consists of a plurality of convolution-relu activation function sequence and a convolution-relu activation function-transposed convolution sequence (hereinafter referred to as “convolution-relu-transposed convolution sequence”) in parallel.

The parameters used in the simulation are as follows.
Number of image classes: 10
Number of feature classes: 41
Average number of features per image class: 4
Input size: [224, 224, 3] (224 pixels by 224 pixels, RGB color)
Type of loss function: cross-entropy
Weight learning rate for all layers during feature classification: 0.01 (fixed)
Bias learning rate for all layers during feature classification: 0.02 (fixed)
Weight learning rate for feature identification layers during image classification: 0.001 (fixed)
Bias learning rate for feature identification layers during image classification: 0.002 (fixed)
Weight learning rate for feature classification layers during image classification: 0.001 (fixed)
Bias learning rate for feature classification layers during image classification: 0.002 (fixed)
Weight learning rate for image classification layers: 0.01 (fixed)
Bias learning rate for image classification layers: 0.02 (fixed)
Validation frequency for fully-trained network: 1
Epochs for fully-trained network: 1
Minimum batch size for fully-trained network: 128
Validation frequency for undertrained network: 1
Epochs for undertrained network: 1
Minimum batch size for undertrained network: 128
Validation frequency for prior arts 1 and 2:5
Epochs for prior arts 1 and 2:5
Minimum batch size for prior arts 1 and 2:128
Confidence level below which undertrained network is used: 50.0%
Random reflection axis for image data augmentation: X and Y
Random rotation for image data augmentation: −20 deg to +20 deg
Random rescaling for image data augmentation: 0.8 to 1.2
Random horizontal translation for image data augmentation: −20 pixels to +20 pixels
Random vertical translation for image data augmentation: −20 pixels to +20 pixels
Data source for validation: Randomly split from training data.
Amount of training data to use for validation: 30%
Orientation of training sample images: front-view and side-view
Orientation of testing images: rear view

The number of features associated with each image class is selected based on the features that are likely to influence human's classification of the particular image class. Therefore, different number of features are associated with different image classes. Furthermore, the weight learning rate and the bias learning rate for feature identification layers are set equal to the ones for the feature classification layer in order to update both the feature identification layers and the feature classification layer equally, while the weight learning rate and the bias learning rate for the image classification layer are set 10 times as large as the feature identification layers and the feature classification layer in order to freeze the feature identification layers and the feature classification layer during the training of the image classification layer.

The confidence level is the sum of the feature percentages associated with one of the feature classifications below which an undertrained network is used. High confidence level implies that the image is similar to some of the training sample images, while low confidence level implies the image is significantly different needing an undertrained network to correctly classify the image.

The 10 image classes used in this simulation are airplane, bird, car, cat, cow, dog, hamster, horse, rabbit, and ship. On the other hand, the 41 feature classes used are beak, cat's ear, cow's ear, dog's ear, hamster's ear, horse's ear, rabbit's ear, bird's eye, cat's eye, cow's eye, dog's eye, hamster's eye, horse's eye, rabbit's eye, feather, cat's fur, hamster's fur, rabbit's fur, head light, horn, mast, metal surface, airplane's perimeter, bird's perimeter, car's perimeter, cat's perimeter, cow's perimeter, dog's perimeter, hamster's perimeter, horse's perimeter, rabbit's perimeter, ship's perimeter, plastic surface, sea, sky, steering wheel, tire, water, wind shield, airplane's wing, bird's wing, and wooden surface. The image classes and the feature classes are the ones that the prior arts 1 and 2 have difficulty distinguishing.

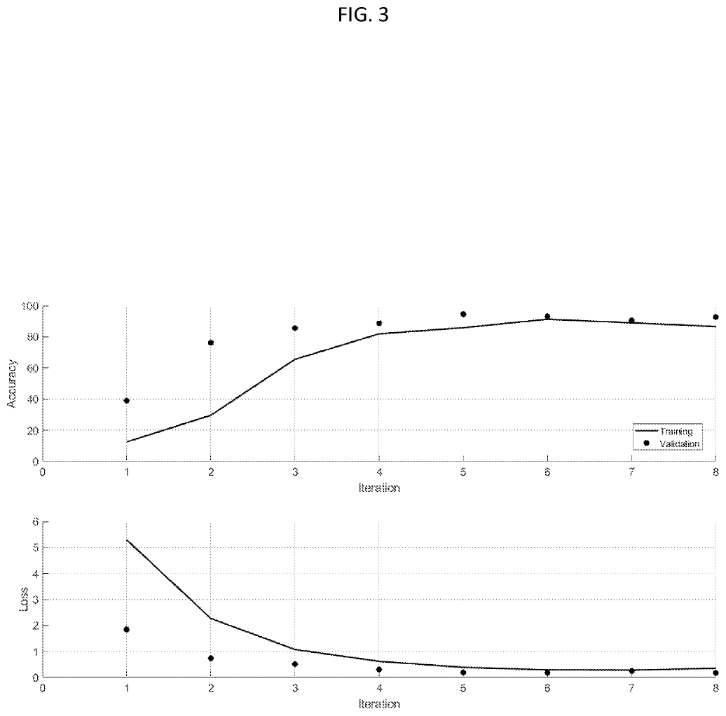

FIG. 3 is a simulation result of an exemplary embodiment of the invention showing accuracy and loss in training and validating the neural network. In FIG. 3 solid lines represent the accuracy and loss for training, while dots represent those for validation. For training and validation, the accuracy is approaching 86.7% and 92.8% respectively, while the loss is approaching 0.4% and 0.2% respectively.

The neural network of the present invention was supplied with a rear-view image of a cat, which is significantly different from the training sample images including only front- and side-view images. Then, the features classified by a fully-trained network were as follows.
Cow's perimeter 8.8%
Cat's fur 8.7%
Cat's perimeter 6.8%
Dog's perimeter 6.7%
Cat's eye 6.5%
   The confidence level is 24.3% that is below 50.0%, therefore an undertrained network is used to reclassify the features. The result is as follows.
Cat's fur 32.1%
Cat's perimeter 23.5%
Cat's ear 13.9%
Cat's eye 10.4%
Dog's ear 2.1%
   This time the confidence level based on the first three dominant features is 69.5% that exceeds 50.0%. implying that it is likely the image is a cat. The fourth feature “Cat's eye” was incorrectly detected because the neural network misinterpreted the cat's leopard pattern as eyes.

The neural network of the present invention identified the image as follows.
Cat 40.0%
Horse 24.6%
Airplane 13.5%
Dog 12.0%
Bird 7.0%
   Although the image for testing is significantly different from the training sample images, the neural network of the present invention correctly classified the image.

It should also be noted that the convolution-relu activation function-transposed convolution sequence in parallel with the convolution-relu activation function sequence allows the neural network to classify features of the images whose source images are of various resolutions, improving the accuracy of feature classification.

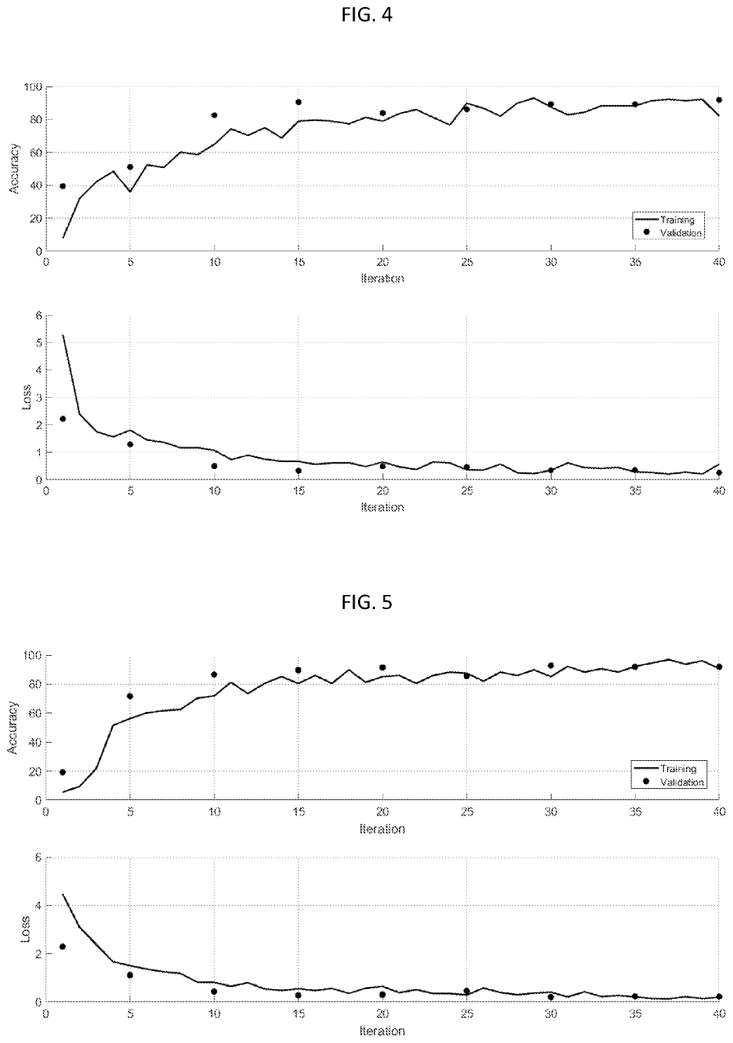

FIG. 4 is a simulation result showing accuracy and loss in training and validating the neural network according to the prior art 1. In FIG. 4 solid lines represent the accuracy and loss for training, while dots represent those for validation. For training and validation, the accuracy is approaching 82.0% and 91.9% respectively, while the loss is approaching 0.6% and 0.3% respectively.

The neural network of the prior art 1 was supplied with a rear-view image of a cat, which is significantly different from the training samples. Then, the features classified by the neural networks were as follows.
Cat's perimeter 28.4%
Cat's ear 22.0%
Cat's eye 20.4%
Cat's fur 17.5%
Dog's perimeter 1.1%
   Three out of 4 dominant features are correct where “cat's eye” is incorrectly detected for the same reason as in the simulation of the present invention. The confidence level based on the correct three features is 67.9% that is less than the present invention.

The neural network of the prior art 1 classified the images as follows.
Cat 33.1%
Bird 23.1%
Dog 22.0%
Horse 6.0%
Hamster 5.1%
   The prior art 1 correctly classifies the image based on the features detected but with probability less than that for the present invention.

Next the prior art 2 consisting of GoogLeNet and SqueezeNet is examined. The prior art 2 compares the historical performance of GoogLeNet and SqueezeNet for the particular type of image, then adopts the one likely to produce the best result. GoogLeNet and SqueezeNet are selected for the simulation as they are some of the best-performing neural networks for image classification at the time of publication of the present invention.

FIG. 5 is a simulation result showing accuracy and loss in training and validating GoogLeNet used as a part of the prior art 2. In FIG. 5 solid lines represent the accuracy and loss for training, while dots represent those for validation. For training and validation, the accuracy is approaching 90.6% and 91.9% respectively, while the loss is approaching 0.2%.

GoogLeNet trained above is supplied with aforementioned rear-view image of a cat. Then, the image was classified by the neural network as follows.
Dog 39.4%
Bird 18.2%
Horse 14.3%
Cow 9.2%
Cat 8.6%
   The result indicates that GoogLeNet fails to classify the image significantly different from the training sample images. The difficulty of classifying the image comes about as a result of fitting the weights to the details that are more than necessary to discriminate the image.

Furthermore, SqueezeNet is trained with the same set of sample images as above. Supplied with the same rear-view image of the cat, SqueezeNet produced the following classification result.
Bird 23.5%
Horse 14.9%
Rabbit 14.1%
Cat 13.7%
Dog 11.1%
   The result indicates that SqueezeNet fails to classify the image significantly different from the training sample images for the same reason as GoogLeNet. Thus, the prior art 2 using GoogLeNet and SqueezeNet is not capable of correctly classify the image.

The present invention can not only correctly classify the image that differs significantly from the training sample images, but also classify with higher probability than the prior arts 1 and 2. The improved performance of the present invention is due to the undertrained network fitting only the features essential to discriminate the image from other class of images, and the convolution-relu-transposed convolution sequence allowing the neural network to properly respond to features similar to those present in the training sample images.

Although the above simulation assumes an undertrained network, a plurality of undertrained networks can be used to properly fit the image to be classified. Moreover, the convolution-relu-transposed convolution sequence can be accompanied by a plurality of sequences of other layer types in parallel.

While, in the above simulation, a single feature classification layer and a single image classification layer are considered, the feature classification layer and the image classification layer can also be extended to more than two dense layers. Alternatively, the dense layers can be replaced with fuzzification-inference-defuzzification sequence.

The present invention can be applied, with a minor modification apparent to those skilled in the art, to a variety of electromechanical systems including vehicles, airplanes, and surgery robots.

The neural network for image classification and classification method thereof in the foregoing embodiment can be realized as an application specific integrated circuit (ASIC) or software embedded on a microcontroller.

The described embodiments of the present invention are only exemplary and numerous variations thereof apparent to those skilled in the art are intended to be within the scope of the current invention as defined in the following claims.

The invention claimed is:

1. A system for image classification, the system comprising:
an image input device receiving an image and sending the image to a feature identification unit;
the feature identification unit receiving the image from the image input device and an undertrained network selection signal from a feature classification evaluator, identifying a plurality of features using an undertrained network, and sending a plurality of identified features to a feature classification unit;
the feature classification unit receiving the identified features from the feature identification unit, classifying the identified features, and sending a plurality of feature classifications and a plurality of feature percentages to the feature classification evaluator;
the feature classification evaluator receiving the feature classifications and the feature percentages from the feature classification unit, sending an image classification initiation signal to the image classification unit if sum of the feature percentages associated with one of the feature classifications exceeds a prespecified value, and sending the undertrained network selection signal to the feature identification unit otherwise; and
the image classification unit receiving the image classification initiation signal from the feature classification evaluator, and generating an image classification;

2. A method for image classification, the method comprising:
receiving an image;
identifying a plurality of features of the image, and generating a plurality of identified features;
classifying the identified features, and generating a plurality of feature classifications and a plurality of feature percentages;
checking if sum of the feature percentages associated with one of the feature classifications exceeds a prespecified value;
checking if the neural network was switched for prespecified times;
switching to an undertrained network if the sum of the feature percentages does not exceed the prespecified value, and the neural network was not switched for prespecified times;
notifying the image is unclassifiable if the neural network was switched for prespecified times;
passing the feature classifications to a plurality of image classification layers if the sum of the feature percentages exceeds the prespecified value; and
classifying the image, and generating an image classification.
